(19) United States
(12) Patent Application Publication
(10) Pub. No.: US 2020/0369500 A1
(43) Pub. Date: Nov. 26, 2020

(54) MOBILE WORKING MACHINE HAVING A PIVOTABLE OPERATOR'S CABIN

(71) Applicant: LIEBHERR-HYDRAULIKBAGGER GMBH, Kirchdorf/Iller (DE)

(72) Inventors: Stephan HENKEL, Memmingen (DE); Mincho VARBANOV, Plovdiv (BG)

(21) Appl. No.: 16/882,240

(22) Filed: May 22, 2020

(30) Foreign Application Priority Data
May 22, 2019 (DE) 10 2019 113 621.0

(51) Int. Cl. B66F 9/075

(52) U.S. Cl. CPC B66F 9/0759

(57) ABSTRACT

The invention relates to a mobile working machine that comprises an undercarriage, a superstructure rotatably supported on the undercarriage, a boom pivotably supported at the superstructure, and an operator's cabin mechanically connected to the superstructure via a lifting apparatus. The operator's cabin is adjustable in its height above the ground by means of the lifting apparatus, with the operator's cabin being able to be moved by means of the lifting apparatus from a working position spaced apart from the ground into a mounting position in which the operator's cabin sits on the ground. The lifting apparatus further comprises in accordance with the invention a lifting arm that is arranged between the operator's cabin and the superstructure and that is pivotably supported at the superstructure about two non-parallel pivot axes independently of one another.

### CROSS-REFERENCE TO RELATED APPLICATION

The present application claims priority to German Patent Application No. 10 2019 113 621.0 filed on May 22, 2019. The entire contents of the above-listed application is hereby incorporated by reference for all purposes.

### TECHNICAL FIELD

The present invention relates to a mobile working machine in accordance with the preamble of claim 1.

### BACKGROUND AND SUMMARY

Mobile working machines such as material transfer machines or hydraulic excavators are known in a variety of variants from the prior art. Such working machines frequently have a superstructure rotatably supported on a travelable undercarriage to which, for example, one or more booms can be pivotably connected. Such working machines moreover typically comprise their own operator's cabin arranged at or connected to the superstructure via which the working machine is controlled by the operator when deployed.

Since these operator's cabins are frequently located at a considerable height above the ground, difficulties can arise when the operator mounts and dismounts. A significant danger potential in particular arises from this elevated location of the operator's cabin and there are regularly accidents of the operators on mounting and dismounting.

To eliminate this risk, some known work machines have operator's cabins that can be placed on the ground by means of a lever mechanism for mounting and exiting. With such working machines, however, the superstructure supporting the operator's cabin has to be rotated with respect to the undercarriage, for example by 45°, to have sufficient room for placing down of the operator's cabin on the ground. Additional worksteps thereby result during deployment, which costs additional time. Furthermore, a rotation of the total superstructure in a specific direction or by a specific angle required for the placing down of the operator's cabin may be problematic on a use under restricted space conditions.

To overcome this disadvantage, the present invention sets itself the object of providing a mobile working machine that enables a simple and space-saving placing down of the operator's cabin on the ground.

This object is achieved in accordance with the invention by a mobile working machine having the features of claim 1. The working machine, which is preferably a material transfer machine or an earth-moving machine such as a hydraulic excavator, accordingly comprises an undercarriage, a superstructure rotatably supported on the undercarriage, a boom pivotably supported at the superstructure, and an operator's cabin that is mechanically connected to the superstructure by a lifting apparatus and that is adjustable in height above the ground by means of the lifting apparatus, wherein the operator's cabin can be moved by means of the lifting apparatus from a working position spaced apart from the ground into a mounting position in which the operator's cabin sits on the ground, and vice versa. In the working position, the operator's cabin is located at a certain height above the ground so that the operator has a good overview of the operating site of the working machine and of the working machine itself. The operator's cabin is here typically aligned along the direction of the longitudinal axis of the superstructure.

In accordance with the invention, the lifting apparatus comprises a lifting arm that is arranged between the operator's cabin and the superstructure, i.e. is connected thereto, and that is pivotably supported about two non-parallel pivot axes at the superstructure. The lifting arm is in this respect pivotable about the two pivot axes independent of one another. Two independent degrees of freedom of rotational movement thereby result for the lifting arm. The pivot axes are advantageously arranged perpendicular to one another. The lifting arm can in this process be configured as linear or curved or kinked once, or a multiple of times and can comprise a plurality of individual arms and joints.

The operator's cabin can thereby not only be pivoted in a single plane, for example a vertical plane, but the lifting apparatus can also additionally pivot laterally. A rotation of the superstructure thus no longer has to be used for the lateral positioning of the operator's cabin on the placing down, but the lifting apparatus in accordance with the invention rather has sufficiently independent degrees of freedom to place the operator's cabin on the ground at a specific site, in particular laterally next to the working machine, independently of the position of the superstructure, in particular with a superstructure aligned in the direction of travel. The placing down of the operator's cabin and the moving of the operator's cabin into an elevated working position are thereby simplified.

Advantageous embodiments of the invention result from the dependent claims and from the following description.

Provision is made in an embodiment that the lifting arm at the operator's cabin is pivotably supported about two non-parallel pivot axes independent of one another. These pivot axes are also preferably perpendicular to one another. Since now both the connection between the lifting arm and the superstructure and the connection between the lifting arm and the operator's cabin respectively have two non-parallel pivot axes, the operator's cabin can be aligned independent of the position or orientation of the lifting arm. It is in particular possible to keep the alignment of the operator's cabin, for example in the direction of travel of the working machine, constant or substantially constant independent of the movement of the lifting apparatus. It is likewise thereby possible to only pivot the operator's cabin in an elevated working position to, for example, obtain a better view of the material to be moved by means of the working machine.

Provision is made in a further embodiment that the two non-parallel pivot axes, that is, the pivot axes of the connection lifting arm/superstructure and/or of the connection lifting arm/operator's cabin, are a vertical axis and a horizontal pivot axis. The horizontal pivot axis at the superstructure serves the adjustment of the height of the operator's cabin, while the vertical pivot axis at the superstructure serves the lateral adjustment or outward pivoting of the lifting arm or of the operator's cabin. The horizontal pivot axis between the lifting arm and the operator's cabin serves the setting or the compensating of the angle of inclination of the operator's cabin, whereas the vertical pivot axis between the lifting arm and the operator's cabin serves the setting or compensating of the angle between the operator's cabin and the superstructure and the rotation of the operator's cabin in a horizontal plane. The operator's cabin can therefore be moved or aligned as desired, which increases flexibility and enables a very space-saving placing down of the operator's cabin that is ideally adapted to the current deployment situation.

Provision is made in a further embodiment that the lifting apparatus comprises a parallelogram guidance, wherein the lifting arm is designed as a twin arm and wherein each arm of the twin arm is respectively pivotably supported at the superstructure and at the operator's cabin about a pivot axis that is in particular horizontal. The operator's cabin thereby automatically maintains its angle of inclination on the vertical pivoting of the lifting arm. The operator's cabin can thus always be held in a horizontal alignment. The lifting arm in this embodiment consequently comprises four horizontal pivot axes, namely a pivot axis for each of the two arms of the twin arm at each end of the lifting arm.

Each arm of the twin arm can consist of an individual or single-piece pivot arm or can comprise a plurality of arms/struts, in particular two, arranged in parallel with one another. The term twin arm in the present case therefore only means that at least two arms are provided that are arranged above one another, that are each connected via their own pivot axis to the superstructure and to the operator's cabin, and that form a parallelogram guidance. These arms of the lifting arm can be linear, or can be curved or kinked once or multiple times. Each arm of the twin arm can in turn comprise one or more individual arms. For example, the upper arm of the twin arm can be a single pivot arm, while the lower arm of the twin arm comprises two individual pivot arms or bars/struts. An actuator controlling the vertical pivot movement can be guided between them up to the lower side of the upper arm. The upper arm can, however, also consist of or comprise a plurality of individual arms.

Provision is made in a further embodiment that the lifting apparatus comprises at least one pivot joint, or two pivot joints, whose axis of rotation is not oriented or aligned horizontally. The axis of rotation of the at least one pivot joint, and in case of two pivot joints, the axes of rotation of both pivot joints, is/are in particular vertically oriented so that in each case a rotation in a horizontal plane results.

Provision is made in a further embodiment that the lifting arm is coupled to the superstructure via a pivot joint and is coupled to the operator's cabin via a further pivot joint. The axis of rotation of the at least one pivot joint therefore forms one of the previously described non-parallel pivot axes between the lifting arm and the superstructure (or, in the presence of a second pivot joint, also one of the non-parallel pivot axes between the lifting arm and the operator's cabin).

Provision is made in a further embodiment that the arms of the twin arm are pivotably connected in an articulated manner to the at least one pivot joint, in particular via horizontal pivot axes. Two pivot joints are preferably provided, with the arms of the twin arm being pivotably connected to both pivot joints in an articulated manner. In this case, the operator's cabin can be moved independently in two directions, in particular vertically and horizontally, i.e. without them also rotating or tilting on a pivoting, with an unchanging alignment or direction of view. The operator's cabin can, for example, thereby be changed both in its height and in its horizontal distance measured perpendicular to the longitudinal axis of the superstructure, without the angle of inclination or the angle to the longitudinal superstructure axis changing.

The at least one pivot joint can furthermore represent a separate component that is connected to the superstructure and/or to the operator's cabin via a corresponding holder or the at least one pivot joint is directly connected to the operator's cabin and/or to the superstructure. The pivot point or the pivot axis of the at least one pivot joint can furthermore be arranged centrally or asymmetrically with respect to the lifting arm. A further pivot arm and/or further joints can furthermore be provided between the pivot joint and the superstructure and/or between the pivot joint and the operator's cabin.

Provision is made in a further embodiment that the lifting apparatus comprises at least one actuator by means of which the at least one pivot joint is rotationally actuable. The pivot or rotational movement about the axis of rotation is therefore performed by means of the actuator.

Provision is made in a further embodiment that the lifting apparatus comprises two pivot joints (one each between the lifting arm and the superstructure and between the lifting arm and the operator's cabin) and correspondingly at least two actuators by means of which the pivot joints are rotationally actuable, in particular independent of one another.

Provision is made in a further embodiment that the lifting apparatus comprises an actuator by means of which the operator's cabin is adjustable in its height, in particular it being vertically pivotable. The actuator in particular moves the lifting arm and pivots it about one of the axes, preferably a vertical pivot axis, about which the lifting arm is pivotably indirectly or directly connected to the superstructure in an articulated manner.

Provision is made in a further embodiment that the actuators of the pivot joint or pivot joints are hydraulic, pneumatic, electrical, and/or mechanical actuators. The actuator responsible for the vertical pivoting can also be a hydraulic, pneumatic, electrical, or mechanical actuator, in particular a hydraulic piston-in-cylinder unit.

Provision is made in a further embodiment that on a movement of the operator's cabin by means of the lifting apparatus from the working position into the mounting position, or vice versa, the angle between the operator's cabin and the superstructure can be held constant, whereas the distance between the operator's cabin and the longitudinal axis of the superstructure is variable. This angle designates the angle between the operator's cabin or the direction in which the front of the operator's cabin is aligned, and the longitudinal axis of the superstructure. The operator's cabin can therefore be constantly held aligned along the longitudinal axis of the superstructure. This holding constant of the alignment of the operator's cabin even on a lateral pivoting of the lifting apparatus or of the lifting arm is made possible by the two pivot joints and by a corresponding control of the associated actuators.

Provision is made in a further embodiment that the lifting apparatus is adapted such that the operator's cabin is always aligned horizontally during a movement of the lifting apparatus, with the lifting apparatus in particular comprising a parallelogram guidance having a lifting arm configured as a twin arm.

Provision is made in a further embodiment that the operator's cabin can be placed on the ground, while the superstructure is aligned in parallel with the undercarriage, i.e. in the direction of travel of the working machine. The superstructure thereby does not have to be separately rotated for the placing down of the operator's cabin. The operator's cabin can in particular be pivoted laterally outwardly and can be placed down on the ground at a site next to the working machine, with the horizontal and lateral alignment of the operator's cabin being able to be held constant and with said operator's cabin facing in the direction of travel.

The operator's cabin preferably also has, in addition to a mounting position and a working position, a transport position in which it is located at substantially the same height as the superstructure and is not laterally outwardly pivoted. The lifting apparatus and the operator's cabin therefore take up minimal space in the transport position for a transport, for example on a flatbed truck. In comparison, the working position can be considered as any desired position of the operator's cabin in which it is not seated on the ground. The working position is in particular located above the superstructure or above the transport position. However, lower positions of the operator's cabin or positions of the operator's cabin at the same height can also be considered as working positions. The lifting apparatus in accordance with the invention here provides great flexibility so that the operator has an ideal overview or visual contact in every position and can adapt it at any time where required.

The present invention furthermore comprises a lifting apparatus for a working machine in accordance with the invention. The previously described embodiments of the working machine with respect to the lifting apparatus equally apply to the lifting apparatus in accordance with the invention. In this respect, the same advantages and properties are present for the working machine in accordance with the invention.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

Further features, details, and advantages of the invention result from the embodiment explained in the following with reference to the Figures.

FIG. 1 shows a first embodiment of a working machine in accordance with the invention in a side view;

FIG. 2 shows the working machine in accordance with the invention of FIG. 1 in a frontal view;

FIG. 3 shows the working machine in accordance with the invention of FIG. 1 in a plan view; and

FIG. 4a shows a first side and frontal views of the working machine in accordance with the invention with the operator's cabin in a working position;

FIG. 4b shows a second side and frontal views of the working machine in accordance with the invention with the operator's cabin in a transport position;

FIG. 4c shows a third side and frontal views of the working machine in accordance with the invention with the operator's cabin in a mounting position.

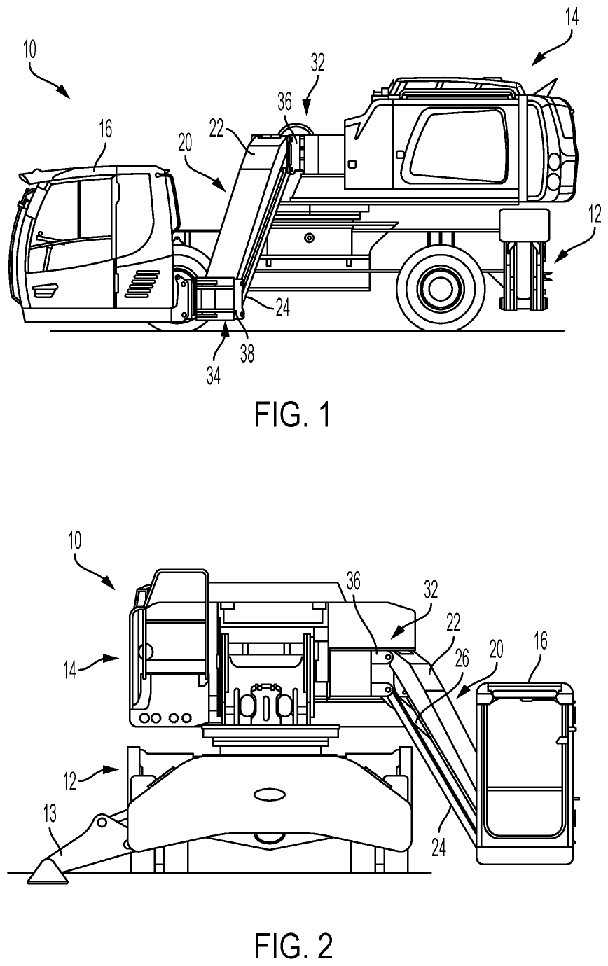

FIGS. 1-4a,b,c are shown approximately to scale.

### DETAILED DESCRIPTION

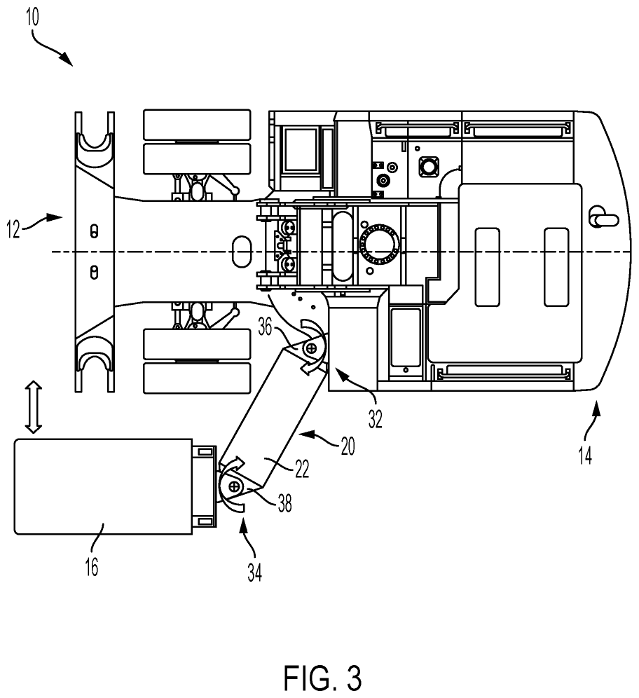

In FIG. 1, an embodiment of the mobile working machine 10 in accordance with the invention is shown in a lateral view, while FIG. 2 shows a frontal view, and FIG. 3 shows a plan view of the working machine 10. The working machine 10 comprises a travelable undercarriage 12, i.e. an undercarriage 12 comprising a chassis, having a plurality of supports 13 which can be folded out and on which a superstructure 14 is rotatably supported. A boom, not shown in further detail here, can be pivotably connected about a horizontal axis to the superstructure 14 in an articulated manner. In general, the working machine in accordance with the invention can be a material transfer machine or an earth-moving machine such as an excavator, in particular a hydraulic excavator.

The working machine 10 can be controlled from an operator's cabin 16 by the operator. The operator's cabin 16 is not directly connected to the superstructure 14, but rather via a lifting apparatus. The lifting apparatus comprises a lifting arm 20 that is respectively connected to the superstructure 14 and to the operator's cabin 16 via an actively actuable pivot joint 32, 34. The lifting arm 20 is designed as a twin arm so that the operator's cabin 16 is vertically pivotable, i.e. adjustable in its height above the ground, via a parallelogram guidance. The twin arm 20 comprises an upper arm 22 that is configured as an individual pivot arm extending over the total width of the lifting arm 20. The twin arm 20 furthermore comprises a lower arm 24 that comprises two individual pivot arms that are configured as bars, extend in parallel, and are arranged next to one another below the upper arm 22.

The upper arm 22 and the lower arm 24 are respectively pivotably supported at one end via a horizontal pivot axis at the pivot joint 32 at the superstructure side. At the other end, the upper and lower arms 22, 24 are likewise respectively pivotably supported at the pivot joint 34 at the operator's cabin side via a horizontal pivot axis. The lifting arm 20 furthermore comprises an actuator 26 that is designed as a hydraulic cylinder and that is arranged between the pivot joint 32 at the superstructure side and the lower side of the upper arm 22 and that connects these components to one another. The lifting arm 20 is vertically pivoted by extending and retracting the actuator 26 so that the operator's cabin 16 is vertically traveled. The parallelogram guidance implemented by the twin arm 20 provides that the operator's cabin 16 always, i.e. in every position, has the same angle of inclination, is therefore in particular horizontally aligned.

As can above all easily be recognized in FIG. 3, the operator's cabin 16 cannot only be adjusted in its height above the ground by means of the lifting apparatus in accordance with the invention, but also in its lateral distance from the superstructure 14 or from the longitudinal axis 40 of the superstructure 14. It is in particular possible that the operator's cabin 16 is always aligned along the longitudinal axis 40 of the superstructure 14 and is laterally pivoted or moved with respect to the superstructure 14 on a movement by means of the lifting apparatus such as the distance in the direction of the perpendicular from the longitudinal axis 40, which distance is shown as a double arrow in FIG. 3, is variable independently of the height of the operator's cabin 16. This is made possible in that the lifting arm 20 is coupled to the superstructure 14 and to the operator's cabin 16 via two pivot joints 32, 34. The pivot joints 32, 34 each have a vertical axis of rotation about which they are rotationally movable or rotatable independently of one another by means of actuators. This is indicated by the black arrows in FIG. 3.

The rotational parts of the pivot joints 32, 34 respectively facing in the direction of the lifting arm 20 are for this purpose configured as holders 36, 38 to which the upper and lower arms 22, 24 of the lifting arm 20 are connected in an articulated manner. The respective other rotational parts of the pivot joints 32, 34 are fixedly connected to the operator's cabin 16 and to the superstructure 14. The operator's cabin 16 can be laterally pivoted by a correspondingly synchronized actuation in opposite directions of the actuators of the pivot joints 32, 34 without the angle with respect to the superstructure 14 changing.

The operator's cabin 16 is consequently independently adjustable both in its height above the ground and in its distance from the superstructure 14 by means of the lifting apparatus in accordance with the invention. It is thereby possible, in comparison with known solutions in which operator's cabins are fastened to lifting arms aligned along the longitudinal direction of the superstructure and only vertically pivotable, to place the operator's cabin 16 on the ground laterally next to the working machine 10 or the undercarriage 12 (mounting position) without the superstructure 14 having to be separately rotated with respect to the undercarriage 12. The operator's cabin 16 can thus be moved into the mounting position in a space saving manner while the superstructure 14 remains aligned in the direction of travel of the working machine 10 (in the present example, this means that the longitudinal axes of the undercarriage 12 and of the superstructure 14 are aligned in parallel).

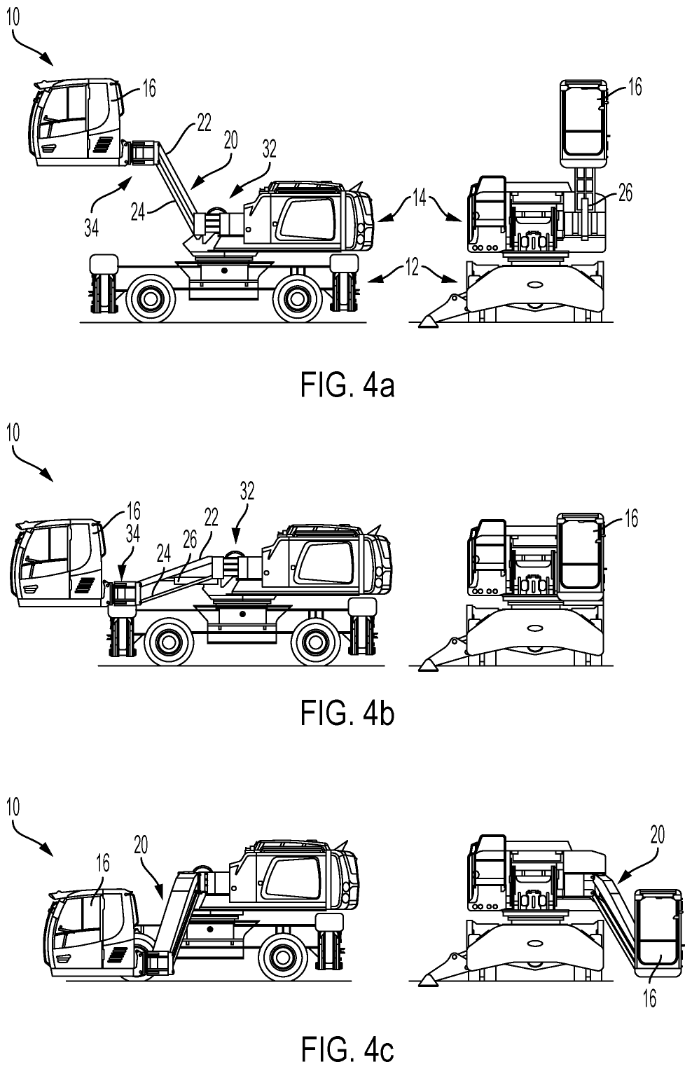

FIGS. 4a-c show the embodiment of the working machine 10 in accordance with the invention shown in FIGS. 1-3 in a respective side view (left illustrations) and in a frontal view (right illustrations) for three different positions of the operator's cabin 16 such as in a working position (FIG. 4a), in the transport position (FIG. 4b), and in the mounting position (FIG. 4c).

In the mounting position, the operator's cabin 16 is placed on the ground laterally next to the undercarriage 12 so that it can be mounted or exited safely and comfortably by the operator.

In the transport position, the operator's cabin 16 is at a specific height above the ground, namely approximately at the height of the superstructure 14. In addition, the operator's cabin 16 is not laterally outwardly pivoted so that the operator's cabin 16 and the lifting apparatus take up as little space as possible or do not project or only minimally project over the vehicles edges. In this position, the working machine 10 can be transported in a space-saving manner on a flatbed truck, for example.

In the working position, the operator's cabin 16 is located at a certain height above the ground, for example (as shown in FIG. 4a) above the height of the superstructure 14 so that the operator has a good overview of the operating site and of the working machine 10. It is possible by means of the lifting apparatus to move the operator's cabin 16 into a plurality of different working positions that are adapted to the respective deployment situation. For example, the operator's cabin 16 can only be rotated with respect to the lifting arm 20 by means of the pivot joint 34 at the cabin side. The height can be set via the actuator 26. Independently of this, the operator's cabin 16 can also be moved laterally relative to the superstructure 14, with the relative angle to the longitudinal axis 40 of the superstructure 14 either being able to be held constant or being able to be varied.

Alternatively to the embodiment shown in the Figures, provision can also be made that only a single pivot joint 32 is present between the lifting arm 20 and the superstructure 14, with the angle between the lifting arm 20 and the operator's cabin 16 being fixed. It is also possible with such a variant to place the operator's cabin 16 next to the working machine 10 in a space saving manner without having to rotate the superstructure 14 with respect to the undercarriage 12.

It is furthermore possible that the lifting arm 20 comprises a plurality of lower lifting arms or lower pivot arms connected via joints and/or that further lifting arms or pivot arms are provided between the pivot joint 32 and the superstructure 14 and/or the pivot joint 34 and the operator's cabin 16.

FIGS. 1-4 a, b, c show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, an element or step recited in the singular and proceeded with the word “a” or “an” should be understood as not excluding plural of said elements or steps, unless such exclusion is explicitly stated. References to “one embodiment” or “one example” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property. The terms “including” and “in which” are used as the plain-language equivalents of the respective terms “comprising” and “wherein.” Moreover, the terms “first,” “second,” and “third,” etc., are used merely as labels, and are not intended to impose numerical requirements or a particular positional order on their objects.

This written description uses examples to disclose the invention and to enable a person of ordinary skill in the relevant art to make and practice the invention, including making and using any devices or systems and performing any incorporated methods. The patentable scope of the invention is defined by the claims. Such other examples are within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be combined by one of ordinary skill in the art to construct additional embodiments and techniques in accordance with principles of this application.

1. A mobile working machine comprising an under carriage, a superstructure rotatably supported on an undercarriage, a boom pivotably supported at the superstructure, and an operator's cabin that is mechanically connected to the superstructure by a lifting apparatus and that is adjustable in height above a ground by the lifting apparatus, wherein the operator's cabin can be moved by means of the lifting apparatus from a working position spaced apart from the ground to a mounting position in which the operator's cabin sits on the ground, and vice versa,
wherein
the lifting apparatus comprises a lifting arm that is arranged between the operator's cabin and the superstructure and that is pivotably supported at the superstructure about two non-parallel pivot axes independent of one another.

2. A working machine in accordance with claim 1, wherein the lifting arm at the operator's cabin is pivotably supported about the two non-parallel pivot axes independent of one another.

3. A working machine in accordance with claim 1, wherein the two non-parallel pivot axes are a vertical and a horizontal pivot axis.

4. A working machine in accordance with claim 3, wherein the lifting apparatus comprises a parallelogram guidance, wherein the lifting arm is designed as a twin arm and wherein each arm of the twin arm is respectively pivotably supported at the superstructure and at the operator's cabin about the horizontal pivot axis.

5. A working machine in accordance with claim 4, wherein the lifting apparatus comprises at least one or two pivot joints whose axes of rotation are not oriented horizontally, the axes of rotation being vertically oriented.

6. A working machine in accordance with claim 5, wherein the lifting arm is coupled to the superstructure via a pivot joint of the two pivot joints and is coupled to the operator's cabin via another pivot joint of the two pivot joints.

7. A working machine in accordance with claim 5, wherein the each arm of the twin arm are pivotably supported at least one of the two pivot joints.

8. A working machine in accordance with claim 5, wherein the lifting apparatus comprises at least one actuator by means of which the at least one of the two pivot joints is rotationally actuable.

9. A working machine in accordance with claim 5, wherein the lifting apparatus comprises two actuators and the two pivot joints, with the two pivot joints being rotationally actuable by means of the actuators, in particular independently of one another.

10. A working machine in accordance with claim 9, wherein the actuators are controllable such that on a movement of the operator's cabin by means of the lifting apparatus from the working position to the mounting position, or vice versa, an angle between the operator's cabin and the superstructure can be held constant, whereas a distance between the operator's cabin and a longitudinal axis of the superstructure is variable.

11. A working machine in accordance with claim 9, wherein the actuators are hydraulic, pneumatic, electrical, or mechanical actuators.

12. A working machine in accordance with claim 1, wherein the lifting apparatus comprises an actuator by means of which the operator's cabin is adjustable in its height, in particular vertically pivotable.

13. A working machine in accordance with claim 4, wherein the lifting apparatus is adapted such that the operator's cabin is always aligned horizontally on a movement of the lifting apparatus, with the lifting apparatus in particular comprising a parallelogram guidance having a lifting arm configured as the twin arm.

14. A working machine in accordance with claim 1, wherein the operator's cabin is configured to be placed on the ground, while the superstructure is aligned in parallel with the undercarriage in a direction of travel of the working machine.
